(19) United States
(12) Patent Application Publication
(10) Pub. No.: US 2023/0116331 A1
(43) Pub. Date: Apr. 13, 2023

(54) METHOD OF OPERATING A DRYWALL SCREWDRIVER, COMPUTER PROGRAM AND DRYWALL SCREWDRIVER

(71) Applicant: Metabowerke GmbH, Nuertingen (DE)

(72) Inventor: Frank Matheis, Reichenbach (DE)

(21) Appl. No.: 17/891,479

(22) Filed: Aug. 19, 2022

(30) Foreign Application Priority Data
Aug. 23, 2021 (DE) 10 2021 121 777.6

(51) Int. Cl. B25B 21/00; B25B 23/00

(52) U.S. Cl. CPC B25B 21/002; B25B 23/0064

(57) ABSTRACT

The invention relates to a method for operating a drywall screwdriver (1), an electric motor (3) of the drywall screwdriver (1) being driven by means of a plurality of temporally spaced individual pulses (11) in order to allow a user to influence the countersinking of a screw (7) in a workpiece (10) in pulses. According to the invention, a screwing tool (8) that is mechanically coupled to the electric motor (3) and can be brought into engagement with the screw (7) is moved further by a predetermined angle of rotation (a) with each of the individual pulses (11).

### CROSS-REFERENCE TO RELATED APPLICATIONS

This application claims priority to German Patent Application No. 10 2021 121 777.6 filed Aug. 23, 2021.

### FIELD OF THE INVENTION

The present disclosure relates to a drywall screwdriver, and systems and methods, computing platforms, and storage media for operating the same, an electric motor of the drywall screwdriver being driven by means of a plurality of temporally spaced individual pulses.

The present disclosure further relates to a drywall screwdriver having an electric motor and a control device, the control device being configured and electrically connected to the electric motor in order to drive the electric motor by means of a plurality of temporally spaced individual pulses.

### BACKGROUND OF THE INVENTION

Dry construction primarily consists of connecting plate-shaped workpieces together using screws. Generally, countersunk head screws are used, which should be flush with the surface of the workpiece, for example plasterboard or a wooden panel, after being screwed in.

In order to actuate or countersink the screws, electric machine tools such as drill/drivers or cordless screwdrivers are generally used. In the case of conventional drill/drivers, however, it is comparatively difficult for the user to influence the countersinking of the screw in a controlled manner. This often results in the screw subsequently not being flush, for example penetrating too deeply into the workpiece or protruding from the surface of the workpiece with the screw head. In particular, readjusting a screw that has already been partially screwed in is usually difficult to control because the starting torque can be comparatively high and can subsequently decrease rapidly, which is why the user can then no longer stop the screw-in operation before the screw ends up screwed too deeply into the workpiece.

To remedy this, special drywall screwdrivers are used to allow a screw to be screwed into a plate-shaped workpiece with improved control.

For this purpose, these drywall screwdrivers have, for example, a mechanical depth stop.

However, it has been found that, even with a mechanical depth stop, the screwing operation sometimes does not lead to a satisfactory result, in particular if the user of the drywall screwdriver does not align the drywall screwdriver sufficiently orthogonally with respect to the plate-shaped component.

To further improve the possibility of control for the user, some drywall screwdrivers utilize what is referred to as an “impulse mode.” In this operation mode, the electric motor of the drywall screwdriver is driven by means of a plurality of temporally spaced individual pulses, which allows the user to influence the countersinking of the screw in the workpiece in pulses and therefore with improved control. Between the individual pulses, the user has sufficient time to control the screwing result and, optionally, to stop the screwing operation in time.

However, the aforementioned impulse mode also does not always lead to a desired result and in particular often nevertheless causes the screw to be screwed in too deeply. In particular, if the torque changes in an unforeseeable manner during the screw-in operation, which is regularly the case in a readjustment operation, then the screw will often be screwed in too deeply.

It is therefore necessary to further improve the known drywall screwdriver.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

As described above, the present disclosure relates to a drywall screwdriver, and systems and methods, computing platforms, and storage media for operating the same that provides the user with an improved influence on the countersinking of a screw, in particular to screw the screw into a workpiece up to a provided depth with high precision.

In some instances, the present disclosure is configured to provide a computer program to carry out such a method.

Finally, in other cases, it is contemplated that the present disclosure provides a drywall screwdriver configured to allow the user improved control of the countersinking of a screw, in particular to screw the screw into a workpiece up to a provided depth with high precision.

### BRIEF DESCRIPTION OF THE DRAWINGS

The objects, features, and attendant advantages of the present disclosure are fully appreciated as the same becomes better understood when considered in conjunction with the accompanying drawings, which in like reference characters designate the same or similar parts through the several views shown.

FIG. 1 shows a drywall screwdriver according to an embodiment of the present disclosure; and

FIG. 2 shows a plurality of temporally spaced individual pulses for operating the electric motor of the drywall screwdriver according to an embodiment of the present disclosure.

### DETAILED DESCRIPTION

The embodiments described below are not intended to limit the invention to the precise form disclosed, nor are they intended to be exhaustive. Rather, the embodiment is presented to provide a description so that others skilled in the art may utilize its teachings.

Technology continues to develop, and elements of the described and disclosed embodiments may be replaced by improved and enhanced items, however the teaching of the present disclosure inherently discloses elements used in embodiments incorporating technology available at the time of this disclosure.

The invention present disclosure relates to a drywall screwdriver, and systems and methods, computing platforms, and storage media for operating the same, an electric motor of the drywall screwdriver being driven by means of a plurality of temporally spaced individual pulses in order to allow a user to influence the countersinking of a screw in a workpiece in pulses.

By operating the electric motor by means of the temporally spaced individual pulses, the user is given sufficient time between each of the individual pulses to assess whether or not a further individual pulse is required to countersink the screw. The user can thus stop the screwing operation in time if necessary.

According to an embodiment of the present disclosure, a screwing tool (e.g. a bit that can be brought into engagement with a screw head of the screw) that is mechanically coupled to the electric motor and can be brought into engagement with the screw is moved further by a predetermined angle of rotation with each of the individual pulses.

The screwing tool can preferably be detachably or interchangeably connected to the drywall screwdriver, for example to a drive shaft of the drywall screwdriver, which drive shaft is driven by a rotor of the electric motor directly or via a gear mechanism.

As a result of the screwing tool (and therefore also the screw) being moved further by a predetermined, defined angle of rotation with each of the individual pulses, a path-controlled impulse mode is provided for the drywall screwdriver in order to countersink screw heads in a particularly controlled manner. In particular, the readjustment of a screw can be improved according to the invention.

In some embodiments it is not possible for an individual pulse to predict how far the screw will be rotated and thus countersunk in the workpiece with each individual pulse because, the path traveled by the screw may depend on the respective load or torque. However, in other embodiments, the path-controlled impulse mode is configured to a defined path and/or a defined angle of rotation to be traveled with the electric motor per individual pulse, independently of the applied load.

In some instances, it can be provided that an amplitude and/or duration of the individual pulses is determined independently of the actual torque of the screwing operation. The control of the electric motor can therefore be independent of the actual torque in this respect.

In other cases, it can also be provided that an amplitude and/or duration of the individual pulses is determined in an exclusively path-controlled manner as a function of the angle of rotation of the screwing tool.

For example, at the beginning of each individual pulse, the current actual angle of rotation of the screwing tool can be determined (unless it is already known) and the electric motor can only be driven until it reaches a setpoint angle of rotation in order to move the screwing tool further by the predetermined angle of rotation (difference between the setpoint angle of rotation and the actual angle of rotation). This operation can be repeated for each individual pulse.

In some embodiments of the present disclosure, it can be provided that the predetermined angle of rotation is identical for all individual pulses.

In particular, an angle of rotation that is identical for all individual pulses can be advantageous for providing the user with a good control action and influence on the screwing operation.

However, it can also be provided that the predetermined angle of rotation differs between the individual pulses. For example, it can be provided that the angle of rotation is reduced with each individual pulse in order to provide the user with an increasingly precise possibility of control as the screw-in depth of the screw increases (or as the screw head approaches the workpiece).

In yet another embodiment it can be provided that the individual pulses are rectangular in shape or at least substantially rectangular in shape. In principle, however, a different pulse shape can also be provided, for example a triangular individual pulse.

The individual pulses, in particular the rectangular individual pulses, preferably have a ramp-shaped rise (soft start) and/or a ramp-shaped fall.

In some cases, it can be provided that all successive individual pulses are in each case equally spaced in time.

Individual pulses that are equally spaced in time can provide the user with a particularly good possibility of control.

However, it can also be provided that the time spacing of the successive individual pulses is increased over time in order to provide the user with more and more time as the screw-in depth of the screw increases (or as the screw head approaches the workpiece) to check the respective screwing result and, optionally, to stop the screwing operation.

In some embodiments it can be provided that successive individual pulses are spaced apart from one another by between 0.1 seconds and 4.0 seconds, preferably by 0.5 seconds to 2.0 seconds, for example spaced apart from one another by 1.0 seconds to 1.5 seconds.

The time spacing of the individual pulses can in particular be selected in such a way that the user has sufficient time between the individual pulses to detect the screw-in depth visually or by other means and, optionally, to stop the screwing operation before a further individual pulse. The time between the individual pulses can also optionally be adjusted, for example by means of a potentiometer that is operably accessible to the user.

In some embodiments it can be provided that, to detect the angle of rotation of the screwing tool, measured values of a position sensor of the electric motor are used, which position sensor detects the position of a rotor of the electric motor relative to a stator of the electric motor.

The detection of the angle of rotation in the electric motor in the region of the electric motor or on the drive shaft has proved particularly suitable. In principle, the angle of rotation can, however, also be detected on the screwing tool itself.

Any sensors can be suitable for detecting the angle of rotation, for example yaw rate sensors or rotary encoders, in particular incremental encoders or absolute encoders.

In another embodiment it can be provided that a brushless direct current motor is used as an electric motor.

The use of a brushless direct current motor can be advantageous because brushless direct current motors can be used particularly efficiently with battery-operated electric tools and because brushless direct current motors also generally already have a corresponding sensor system for detecting the position of the rotor relative to the stator, whereby the angle of rotation can be detected particularly easily for the method according to the invention using the existing sensor system.

A defined number of motor steps of the brushless direct current motor can be traveled with each individual pulse.

In another embodiment it can be provided that a mechanical depth stop is provided for the drywall screwdriver.

A combination of a depth stop with the proposed impulse mode can again improve precision when screwing in the screw. The invention is therefore in particular advantageous for use with a drywall screwdriver that has a corresponding depth stop.

The method according to the present disclosure may be used in dry construction for screwing screws into plasterboard or into wooden panels.

The present disclosure also relates to a computer program comprising control commands that cause a control device to carry out the method according to the explanations above and below when the program is executed by said control device.

The control device can be a control device of the drywall screwdriver.

The control device can in particular be designed as a microprocessor. Instead of a microprocessor, any other device can also be provided for implementing the control device, for example one or more arrangements of discrete electrical components on a circuit board, a programmable logic controller (PLC), an application-specific integrated circuit (ASIC) or any other programmable circuit, for example also a field programmable gate array (FPGA) and/or a programmable logic array (PLA).

The present disclosure also relates to a drywall screwdriver having an electric motor and a control device, the control device being configured and electrically connected to the electric motor in order to drive the electric motor by means of a plurality of temporally spaced individual pulses in order to allow a user to influence the countersinking of a screw in a workpiece in pulses. The control device is configured to move a screwing tool that can be mechanically coupled to the electric motor and brought into engagement with the screw further by a predetermined angle of rotation with each of the individual pulses.

The proposed drywall screwdriver can thus have a path-controlled impulse mode or a path-controlled impulse function and thus allow defined and particularly controllable screwing in and/or readjustment of screws. Faulty screw connections in the form of screws that have been screwed in too deeply can advantageously be avoided.

Features that have been described in connection with one of the subject matters of the invention, namely the method according to the invention, the computer program and the drywall screwdriver, can also advantageously be implemented for the other subject matters of the invention. Likewise, advantages that have been mentioned in connection with one of the subject matters of the invention can also be understood to relate to the other subject matters of the present disclosure.

In addition, it should be pointed out that terms such as “comprising,” “having” or “with” do not exclude other features or steps. Furthermore, terms such as “a,” “an” or “the” that refer to a single step or feature do not rule out a plurality of features or steps and vice versa.

In an embodiment of the present disclosure, it can, however, also be provided that the features introduced in the present disclosure using the terms “comprising,” “having” or “with” are enumerated exhaustively. Accordingly, one or more enumerations of features can be considered complete within the scope of the present disclosure, for example considered for each claim.

It should be mentioned that designations such as “first” or “second” etc. are used primarily for the sake of distinguishability of respective apparatus or method features and are not necessarily intended to imply that features are mutually dependent or related to one another.

It should also be emphasized that the values and parameters described in the present case include deviations or fluctuations of ±10% or less, preferably ±5% or less, more preferably ±1% or less, and very particularly preferably ±0.1% or less of the respective named value or parameter, unless these deviations are excluded in the implementation of the invention in practice. The specification of ranges by means of initial and final values also includes all values and fractions that are enclosed by the respective named range, in particular the initial and final values and a respective mean value.

Embodiments of the present disclosure are explained in further detail below on the basis of the drawings.

The drawings each show preferred embodiments in which individual features of the present disclosure are shown in combination with each other. Features of an embodiment can also be implemented separately from the other features of the same embodiment and can accordingly be readily combined by a person skilled in the art with features of other embodiments to form further meaningful combinations and subcombinations.

In the drawings, functionally identical elements are provided with the same reference signs.

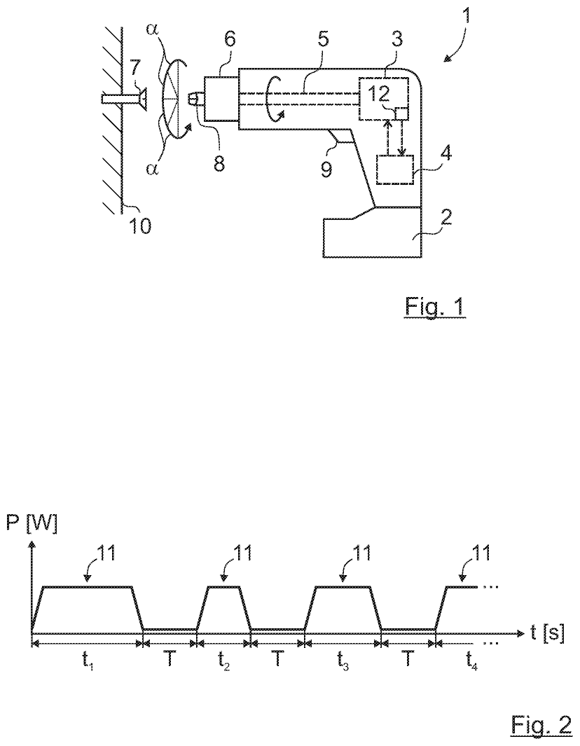

FIG. 1 is a schematic representation of a drywall screwdriver 1 according to an embodiment of the present disclosure. A battery-operated drywall screwdriver 1 that has an interchangeable battery pack 2 is shown by way of example. The drywall screwdriver 1 also has an electric motor 3 and a control device 4. A rotor (not shown in more detail) of the electric motor 3 is connected to a tool receptacle 6 via a drive shaft 5, in which tool receptacle a screwing tool 8 that can be brought into engagement with a screw 7 is fixed.

An actuating switch 9 can be used by a user to actuate the drywall screwdriver 1 in order to screw the screw 7 into a workpiece 10 or countersink said screw in a workpiece 10 in the most controlled manner possible.

The control device 4 is configured and electrically connected to the electric motor 3 in order to drive the electric motor 3 by means of a plurality of temporally spaced individual pulses 11 in order to allow a user to influence the countersinking of a screw 7 in the workpiece 10. For this purpose, the screwing tool 8 is moved further by a predetermined, defined angle of rotation a with each of the individual pulses 11.

In particular, some implementations a computer program that comprises suitable control commands can be designed on the control device 4 for this purpose defining an angle of rotation with each individual pulse 11.

The control device 4 may comprise an electronic storage for storing the computer program, one or more processors, and/or other components. The electronic storage may itself comprise non-transitory storage media that electronically stores information, such as the computer program. The electronic storage media of electronic storage may include one or both of system storage that is provided integrally (i.e., substantially non-removable) and/or removable storage via, for example, a port (e.g., a USB port, a firewire port, etc.).

The processor(s) may be configured to provide information processing capabilities in the control device 4. As such, the processor(s) may include one or more of a digital processor, an analog processor, a digital circuit designed to process information, an analog circuit designed to process information, a state machine, and/or other mechanisms for electronically processing information. In some implementations, processor(s) may include a plurality of processing units. These processing units may be physically located within the control device 4, or processor(s) may represent processing functionality of a plurality of devices operating in coordination. The processor(s) may be configured to execute the plurality of temporally spaced individual pulses of the 11 of the electric motor 3 by software; hardware; firmware; some combination of software, hardware, and/or firmware; and/or other mechanisms for configuring processing capabilities on processor(s).

Correspondingly temporally spaced individual pulses 11 for driving the electric motor 3 are shown by way of example in FIG. 2.

In particular, it can be provided that an amplitude P and/or duration tₙ of the individual pulses 11 is determined independently of the actual torque of the screwing operation. Preferably, an amplitude P and/or duration tₙ of the individual pulses 11 is determined in an exclusively path-controlled manner as a function of provided angle of rotation a of the screwing tool 8. The angle of rotation a is preferably identical for all individual pulses 11.

It can be provided that the individual pulses 11 are substantially rectangular in shape (as shown), with a preferably ramp-shaped rise and/or a ramp-shaped fall.

The respective duration tₙ of the individual pulses 11 can thus vary as a function of the load that is actually applied to the screwing tool 8 or the actually applied torque. Nevertheless, it is preferably provided that all successive individual pulses 11 are in each case equally spaced in time (see constant time T in FIG. 2). In particular, the successive individual pulses 11 can be spaced apart from one another by between 0.5 seconds and 2.0 seconds, for example 1.0 seconds to 1.5 seconds, in order to give the user sufficient time to optionally stop the screwing operation.

To detect the angle of rotation a of the screwing tool 8, measured values of a position sensor 12 or rotation sensor of the electric motor 3 can be used in particular, which position sensor detects the position of the rotor of the electric motor 3 relative to the stator of the electric motor 3. A brushless direct current motor usually already has a corresponding sensor system.

It can optionally be provided that the drywall screwdriver 1 has a mechanical depth stop (not shown) to further optimize the screw-in operation.

1. A method for operating a drywall screwdriver, the method comprising the following method steps:
driving an electric motor of the drywall screwdriver with a plurality of temporally spaced individual pulses configured to allow a user to influence a countersinking of a screw in a workpiece in pulses, and
manipulating a screwing tool that is mechanically coupled to the electric motor and configured to engage with the screw by a predetermined angle of rotation (α) with each pulse of the plurality of temporally spaced individual pulses.

2. The method of claim 1, wherein an amplitude (P) and/or duration (Li) of the plurality of temporally spaced individual pulses is determined independently of a measured torque of the countersinking of the screw.

3. The method of claim 1, wherein an amplitude (P) and/or duration (tₙ) of the plurality of temporally spaced individual pulses is determined in an exclusively path-controlled manner as a function of the predetermined angle of rotation (α) of the screwing tool.

4. The method of claim 1, characterized in that wherein the predetermined angle of rotation (α) is the same for any one of the plurality of temporally spaced individual pulses.

5. The method of claim 1, wherein the plurality of temporally spaced individual pulses are substantially rectangular in shape, with a preferably ramp-shaped rise and/or a ramp-shaped fall.

6. The method of claim 1, wherein any one of the plurality of temporally spaced individual pulses are equally spaced in duration.

7. The method of claim 1, wherein any one of the plurality of temporally spaced individual pulses are spaced apart from one another by between 0.5 seconds and 2.0 seconds intervals, for example spaced apart from one another by 1.0 seconds to 1.5 seconds intervals.

8. The method of claim 1, wherein, measured values of a position sensor of the electric motor are used to detect the predetermined angle of rotation (α) of the screwing tool, the position sensor being configured to detect a change in position of a rotor of the electric motor relative to a stator of the electric motor.

9. The method of claim 1, wherein the electric motor is a brushless direct current motor.

10. The method of claim 1, characterized in that wherein the drywall screwdriver further comprises a mechanical depth stop.

11. A non-transient computer-readable storage medium having instructions embodied thereon, the instructions being executable by one or more processors to perform a method for operating a drywall screwdriver, the method comprising:
receiving, via a control device, an input from a user to direct the drywall screwdriver; and
transmitting, via the control device, a control command signal, wherein the control command signal is configured to:
instruct an electric motor of the drywall screwdriver to transmit a plurality of temporally spaced individual pulses to a screwing tool coupled to the electric motor, and
execute, via the screwing tool, a countersinking of a screw, wherein the screwing tool is configured to manipulate the screw by a predetermined angle of rotation (α) with each pulse of the plurality of temporally spaced individual pulses.

12. (canceled)

13. The method of claim 11, wherein an amplitude (P) and/or duration (tₙ) of the plurality of temporally spaced individual pulses is determined independently of a measured torque of the countersinking of the screw.

14. The method of claim 11, wherein any one of the plurality of temporally spaced individual pulses are spaced apart from one another by between 0.5 seconds and 2.0 seconds intervals, for example spaced apart from one another by 1.0 seconds to 1.5 seconds intervals.

15. The method of claim 11, wherein measured values of a position sensor of the electric motor are used to detect the predetermined angle of rotation (α) of the screwing tool, the position sensor being configured to detects a change in position of a rotor of the electric motor relative to a stator of the electric motor.

16. The method of claim 11, wherein the electric motor is a brushless direct current motor and the drywall screwdriver further comprises a mechanical depth stop.

17. A drywall screwdriver, comprising:
an electric motor configured to facilitate a countersinking of a screw in a workpiece;
a screwing tool mechanically coupled to the electric motor and configured to removably engage with the screw; and
a control device configured to receive and translate instructions from a user and direct, via a control command signal, operation of the electric motor,
wherein the control command signal is configured to instruct the electric motor to transmit a plurality of temporally spaced individual pulses to the screwing tool to facilitate the countersinking of the screw, and
wherein the screwing tool is configured to countersink the screw by a predetermined angle of rotation (α) with each pulse of the plurality of temporally spaced individual pulses.

18. The drywall screwdriver of claim 17, wherein an amplitude (P) and/or duration (tₙ) of the plurality of temporally spaced individual pulses is determined independently of a measured torque of the countersinking of the screw.

19. The drywall screwdriver of claim 17, wherein any one of the plurality of temporally spaced individual pulses are spaced apart from one another by between 0.5 seconds and 2.0 seconds intervals, for example spaced apart from one another by 1.0 seconds to 1.5 seconds intervals.

20. The drywall screwdriver of claim 17, wherein measured values of a position sensor of the electric motor are used to detect the predetermined angle of rotation (α) of the screwing tool, the position sensor being configured to detects a change in position of a rotor of the electric motor relative to a stator of the electric motor.

21. The drywall screwdriver of claim 17, wherein the electric motor is a brushless direct current motor and the drywall screwdriver further comprises a mechanical depth stop.
